(19) United States
(12) Patent Application Publication
(10) Pub. No.: US 2017/0346770 A1
(43) Pub. Date: Nov. 30, 2017

(54) LINK-INVOKED OMNI-CHANNEL CHAT, VOICE AND VIDEO

(71) Applicant: Teledini LLC, Atlanta, GA (US)

(72) Inventors: Steven S. Smithwick, Atlanta, GA (US); Jason L. Deegan, Marietta, GA (US)

(21) Appl. No.: 15/604,027

(22) Filed: May 24, 2017

Related U.S. Application Data
(60) Provisional application No. 62/341,524, filed on May 25, 2016.

(51) Int. Cl. H04L 12/58; H04L 29/08

(52) U.S. Cl. CPC H04L 51/046; H04L 51/10; H04L 51/08; H04L 67/02

(57) ABSTRACT

A method and apparatus to facilitate electronic chat, voice or video that is invoked via an embedded web-link.

### RELATED APPLICATIONS

This application claims priority to U.S. Provisional Patent Application Ser. No. 62/341,524, entitled “Link-Invoked Omni-Channel Chat, Voice And Video,” filed on May 25, 2016.

### BACKGROUND

### Field of the Disclosure

Aspects of the disclosure relate in general to a method and apparatus to enable seamless electronic chat, voice and video via a web-browser. Specifically, embodiments include electronic chat, voice or video that is invoked via an embedded web-link.

### Description of the Related Art

The expression “online chat” comes from the word “chat,” which is an informal conversation.

Online chat refers to communication over the Internet that offers a real-time transmission of text messages from sender to receiver. Chat messages are generally short in order to enable other participants to respond quickly. The quick back-and-forth responses results in a conversation-like communication, which distinguishes chatting from other text-based online communication forms such as Internet forums and email. Online chat may address point-to-point communications as well as multicast communications from one sender to many receivers and voice and video chat, or may be a feature of a web conferencing service.

While online chat is generally text-based, the definition sometimes incorporates video-based web-cam communications and instant messengers.

Vendors (such as merchants) sometimes embed online chat on to their web pages as a form of customer support. Online chat can be implemented via an Internet web browser by using either Extensible Messaging and Presence Protocol (XMPP) or Web Real-Time Communication (WebRTC). XMPP is a communications protocol for message oriented middleware. WebRTC is an API definition drafted by the World Wide Web Consortium (W3C) that supports browser-to-browser applications for voice calling, video chat, and person-to-person (P2P) file sharing without the need of either internal or external plug-ins. In order to implement WebRTC online chat functionality on a vendor's web page, the vendor adds a 3^{rd} party (chat, voice & video provider) code snippet into the web-page. The code snippet placed within the vendor's website page invokes a window so that visitors to that website can begin communication sessions.

Sometimes the added code is incorrectly flagged as malware by web-browsers. The code itself is complex, as it must work universally with different web-browsers. Adding the code into a web-page also requires programming knowledge which prevents many vendors from adding such functionality on to their web pages. Finally, in order to provide secure communications, the WebRTC protocol requires the Hypertext Transfer Protocol Secure (HTTPS), which many websites do not support.

### SUMMARY

Embodiments include a method and apparatus to facilitate electronic chat, voice or video that is invoked via an embedded web-link. Embodiments include a method to establish a communication between a visitor device and a user device without personal contact information. A visitor click is received from the visitor device at a server referencing a unique Uniform Resource Locator (URL). A server processor performs a database lookup with the referenced unique URL. The database lookup retrieves a preferred communication method associated with the user device. The server connects the visitor device and the user device in with an instant message transmitted by the server.

### BRIEF DESCRIPTION OF THE DRAWINGS

The figures below illustrate a method and apparatus to facilitate electronic chat, voice or video that is invoked via an embedded web-link.

FIG. 1 illustrates a system to facilitate electronic chat, voice or video that is invoked via an embedded web-link.

FIG. 2 is a block diagram that depicts a communication and web server embodiment to facilitate electronic chat, voice or video that is invoked via an embedded web-link.

FIG. 3 is a flow chart of a process of creating a unique user Uniform Resource Locator (URL) to enable an electronic chat, voice or video that is invoked via an embedded web-link.

FIG. 4 illustrates a flow chart of a process to enable an electronic chat, voice or video that is invoked via an embedded web-link.

### DETAILED DESCRIPTION

An aspect of the present disclosure is the realization that vendors want to avoid extensive modifications to their website required when adding code to enable online chat. Another aspect includes the understanding that extensive modifications (from the vendor's point of view) can be eliminated by enabling online chat via a web link to a third-party online chat provider.

Aspects of the present disclosure include a method and apparatus to facilitate electronic chat, voice or video that is invoked via an embedded web-link.

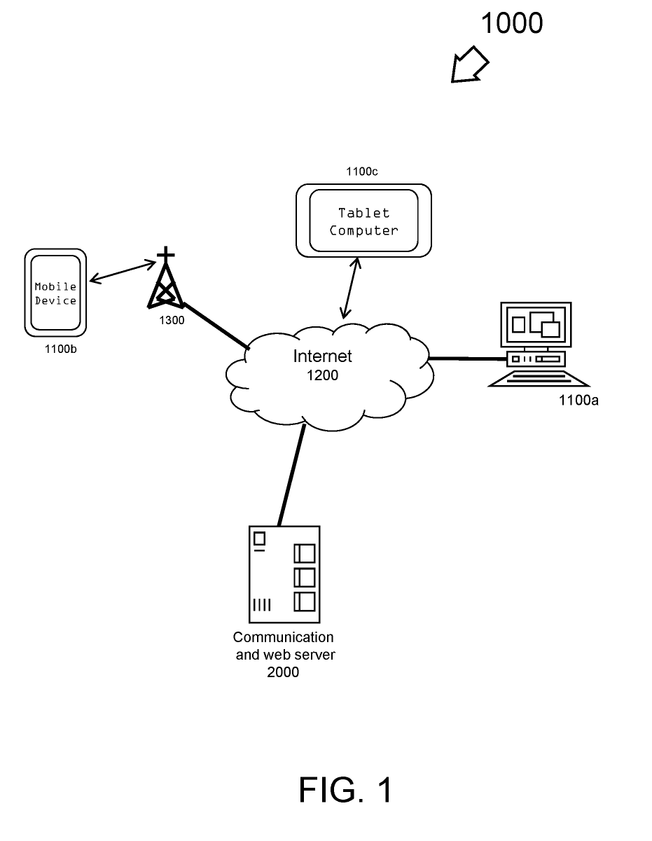

FIG. 1 illustrates a system 1000 to facilitate electronic chat, voice or video that is invoked via an embedded Uniform Resource Locator (URL) (a “web-link”), constructed and operative in accordance with an embodiment of the present disclosure. System 1000 allows user devices, such as computers 1100a, mobile devices 1100b over digital cellular networks 1300, and tablet computers 1100c to communicate via the internet 1200 using electronic chat, voice, or video. In some embodiments, the electronic chat is instant Internet messaging, allowing users to publish (post or send) public (private or generic) links, but chat on private devices without revealing personal contact information. For the purposes of this disclosure, electronic chat, voice, or video is referred to as a “Ramble Chat.”

As shown in FIG. 1, a vendor web page may be any format known in the art, including a mobile-formatted web page. Any linkable web site element (such as an image, combobox, button, icon, or other object) may be used to link to a third-party online chat provider located at a communications and web server 2000, depicted in FIG. 1, as:

<a href=https://chat-invocation-link.com?customer=identified” TARGET=“rambleChat”>[linkable website element]</a>

Once the website element is clicked, a new window may be opened, served by communications and web server 2000.

The communications and web server 2000 may institute the chat using XMPP, WebRTC, or any other messaging protocols, but by using the linking mechanism, the vendor does not need to know any of the messaging protocol specifics whatsoever.

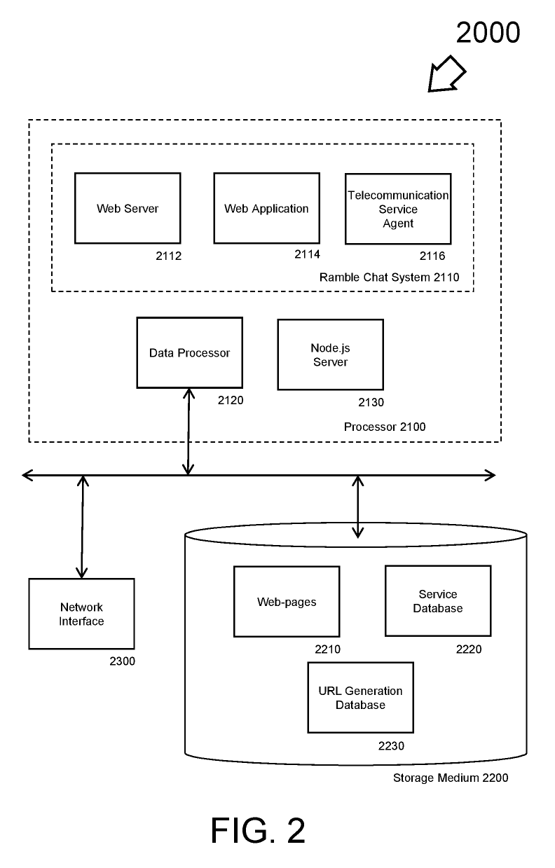

FIG. 2 is a block diagram that depicts a communication and web server embodiment to facilitate electronic chat, voice or video that is invoked via an embedded web-link, constructed and operative in accordance with an embodiment of the present disclosure.

Communications and web server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a ramble chat system 2110, a node.js server 2130, and a data processor 2120.

Data processor 2120 interfaces with storage medium 2200 and network interface 2300. The data processor 2120 enables processor 2100 to locate data on, read data from, and writes data to, these components.

Ramble chat system 2110 is the structure that receives the link via an embedded web-link and facilitates the ramble chat. Ramble chat system 2110 may further comprise a web server 2112, web application 2114, and a telecommunication service agent 2116. The web server 2112 and web application 2114 act as a World-Wide-Web interface that accepts the link from a user. Web application 2114 performs then connects the user to another user based on the URL invoked.

In some embodiments, telecommunication service agent 2116 may initiate electronic chat, voice or video communications between the user clicking on the embedded link unique URL and a user identified by the unique URL.

Node.js server 2130 is an open-source, cross-platform JavaScript run-time environment for executing JavaScript code server-side. In some embodiments, it may assist web server 2112, web application 2114, and telecommunication service agent 2116 in generating a unique URL or setting up the telecommunications link between users.

These structures may be implemented as hardware, firmware, or software encoded on a computer readable medium, such as storage medium 2200. Further details of these components are described with their relation to method embodiments below.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain an web pages 2210, a service database 2220, and a URL generation database 2230. Web pages 2210 are pages served by web server 2112. Service database 2220 includes information about a ramble chat accountholder, including user contact information and any information collected by the ramble chat system 2110. URL generation database 2230 includes an identifier to identify any user registered by the ramble chat system 2110 and their unique URL identifier.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows communications and web server 2000 to communicate with acquirer 1400 and issuer 1500.

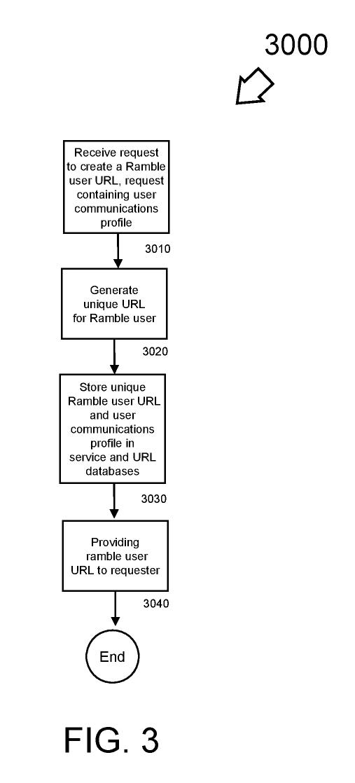

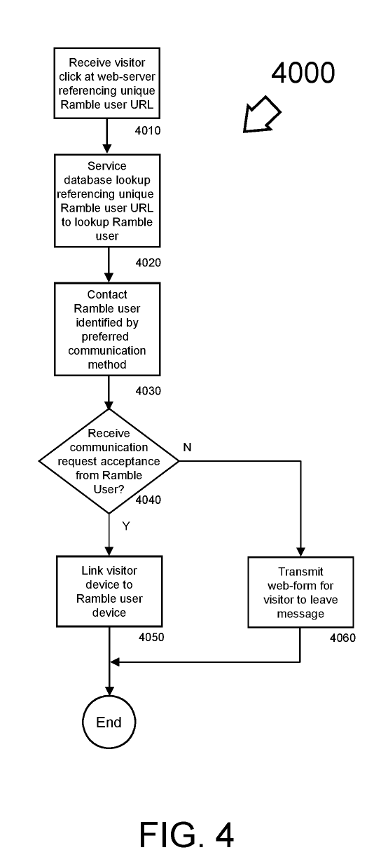

We now turn our attention to a method or process embodiment of the present disclosure, FIG. 3 and FIG. 4. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 is a flow chart of a process 3000 of creating a unique user URL to enable an electronic chat, voice or video that is invoked via an embedded web-link, constructed and operative in accordance with an embodiment of the present disclosure.

At block 3010, communication and web server 2000 receives a request to create a ramble user URL, the request containing a user communication profile. The request is received from an intended user's computing device 1100, and may include computers 1100a, mobile devices 1100b, tablet computers 1100c, and the like. The user communication profile indicates preferred methods of communicating with the intended user. In some embodiments, the user communication profile may include existing intended user telephone numbers, Internet Chat identifiers, video communication identifiers and the like. In other embodiments, ramble chat system 2110 enables electronic chat, voice or video communication links, and only receives communication preferences from the intended users. The information may be received via the network interface 2300 and the web server 2112.

At block 3020, the ramble chat system 2110 generates a unique URL for the intended ramble chat user. In some instances, the unique URL is suggested by the intended ramble chat user, and verified against a URL generation database 2230 to confirm that the URL is unique. In other embodiments, a pseudo random number generator is used to generate the unique URL.

The unique ramble chat user URL and user communications profiles are stored in the URL generation database 2230 and service database 2220, respectively, block 3030. A link is created between the unique ramble chat user URL and the user communication profile. In some embodiments, the URL generation database 2230 and service database 2220 are one database, and both sets of information is stored within a single user profile.

The unique ramble chat user URL is provided to the requester, at block 3040. In some embodiments, the URL is provided via display on a web page via the web server 2112. In other embodiments, the URL is transmitted to the intended user via an application on a mobile device 1100b, via electronic mail, or text message, such as a Short Message Service (SMS) message.

FIG. 4 illustrates a flow chart of a process 4000 to enable an electronic chat, voice or video that is invoked via an embedded web-link, constructed and operative in accordance with an embodiment of the present disclosure.

At block 4010, the network interface 2300 receives a visitor click at web server 2112 referencing a unique ramble chat user URL. The ramble chat system 2110 identifies the reference as a unique ramble chat user URL and performs a service database 2220 lookup to determine the ramble chat user being referenced and their preferred method of communication listed in the user communication profile, block 4020.

At block 4030, ramble chat system 2110 attempts to contact the ramble chat user identified by their preferred communication method. It should be clarified that the communication attempt is a machine-to-machine communication, in that the communication and web server 2000 uses network interface 2300 to communicate with a user device 1100 with the preferred communication method.

If the user identified by the unique URL accepts the communication from the user clicking the link (“the visitor”), at decision block 4040, the ramble chat system 2110 links the visitor device to the ramble chat user device, block 4050.

If the user identified by the unique URL accepts the communication from the user clicking the link (“the visitor”), at decision block 4040, the ramble chat system 2110 provides a web form for the visitor to leave a message.

The previous description of the embodiments is provided to enable any person skilled in the art to practice the disclosure. Thus, the present disclosure is not intended to be limited to the embodiments shown herein, but is to be accorded the widest scope consistent with the principles and features disclosed herein.

What is claimed is:

1. A method to establish a communication between a visitor device and a user device without personal contact information, comprising:
receiving a visitor click from the visitor device at a server referencing a unique Uniform Resource Locator (URL);
performing a database lookup with the referenced unique URL, the database lookup retrieving a preferred communication method associated with the user device;
connecting the visitor device and the user device in with an instant message transmitted by the server.

2. The method of claim 1, wherein the connecting the visitor device and the user device is via a network interface.

3. A server to establish a communication between a visitor device and a user device without personal contact information, comprising:
a network interface configured to receive a visitor click from the visitor device at the server referencing a unique Uniform Resource Locator (URL);
a processor configured to perform a database lookup with the referenced unique URL, the database lookup retrieving a preferred communication method associated with the user device;
the network interface further configured to connect the visitor device and the user device in with an instant message transmitted by the server.

4. A non-transitory computer readable storage medium encoded with data and instructions to establish a communication between a visitor device and a user device without personal contact information, when read by a computing device causes the computing device to:
receive a visitor click from the visitor device at a server referencing a unique Uniform Resource Locator (URL) with a network interface;
perform a database lookup with the referenced unique URL, by a processor, the database lookup retrieving a preferred communication method associated with the user device;
connect the visitor device and the user device in with an instant message transmitted by the server.
